(19) United States
(12) Patent Application Publication
(10) Pub. No.: US 2009/0281849 A1
(43) Pub. Date: Nov. 12, 2009

(54) Systems and methods for developing a mobile network

(75) Inventors: Nigel Choi, San Carlos, CA (US); Mark Schaaf, San Francisco, CA (US)

Correspondence Address: CARR & FERRELL LLP, 2200 GENG ROAD, PALO ALTO, CA, 94303, US

(73) Assignee: AdMob, Inc.

(21) Appl. No.: 12/152,229

(22) Filed: May 12, 2008

(51) Int. Cl. G06F 17/30; G06Q 10/00

(52) U.S. Cl. 705/7; 707/7; 707/E17.032

(57) ABSTRACT

Exemplary systems and methods for developing a mobile network are provided. Exemplary methods include receiving a request to include a mobile network site in a ranked menu of mobile network sites, including the mobile network site in the ranked menu of mobile network sites, sending the ranked menu of mobile network sites to a mobile communications device, receiving a communication from the mobile communications device indicating that the mobile network site should have a different rank, processing the received communication to update the ranked menu of mobile network sites, and sending the updated ranked menu to the mobile communications device. Exemplary systems include a communications module that receives a request to include a mobile network site in a ranked menu of mobile network sites, sends the ranked menu of mobile network sites to a mobile communications device, and receives a communication from the mobile communications device indicating that the mobile network site should have a different rank. A ranking engine includes the mobile network site in the ranked menu of mobile network sites, and processes the received communication to update the ranked menu of mobile network sites. A mobile network site database stores information about the mobile network site and the ranked menu of mobile networks sites.

### FIELD OF THE INVENTION

The present invention relates generally to digital content networks, and more particularly to systems and methods for developing a mobile network.

### DESCRIPTION OF RELATED ART

Conventionally, developing a mobile network accessed by mobile communications devices may be subject to constraints that do not pertain to the Internet as accessed by personal computers. For example, a page of content displayed on a mobile communications device (e.g., a mobile phone or a personal digital assistant) is far smaller than that which may be displayed on a laptop computer. Also, there are presently fewer mobile network sites on mobile networks than there are Internet web sites on the Internet. Additionally, mobile device communication may entail a wireless component that is slow and unreliable when compared to a standard Internet connection, so an activity on a mobile communications device analogous to surfing the Internet with a personal computer by clicking on a series of links is neither efficient nor fruitful. Accordingly, search techniques that are useful on the Internet are not very useful via the use of mobile communications devices over mobile networks. Consequently, there is a need for systems and methods for developing a mobile network.

### BRIEF DESCRIPTION OF THE DRAWINGS

FIG. 1 is a block diagram of an exemplary architecture in which various embodiments of developing a mobile network may be practiced;

FIG. 2 shows an exemplary mobile network builder;

FIG. 3 is a screenshot of an exemplary ranked menu of mobile network sites; and

FIG. 4 is a flow chart of an exemplary method for developing a mobile network.

### SUMMARY OF THE INVENTION

Exemplary methods for developing a mobile network are provided. Such methods include receiving a request to include a mobile network site in a ranked menu of mobile network sites, including the mobile network site in the ranked menu of mobile network sites, sending the ranked menu of mobile network sites to a mobile communications device, receiving a communication from the mobile communications device indicating that the mobile network site should have a different rank, processing the received communication to update the ranked menu of mobile network sites, and sending the updated ranked menu to the mobile communications device. Further methods include receiving information about each time the mobile network site is accessed by the mobile communications device.

Exemplary systems for developing a mobile network are also provided. These systems include a communications module that receives a request to include a mobile network site in a ranked menu of mobile network sites, sends the ranked menu of mobile network sites to a mobile communications device, and receives a communication from the mobile communications device indicating that the mobile network site should have a different rank. A ranking engine includes the mobile network site in the ranked menu of mobile network sites, and processes the received communication to update the ranked menu of mobile network sites. A mobile network site database stores information about the mobile network site and the ranked menu of mobile networks sites, and the communications module sends the updated ranked menu to the mobile communications device.

### DETAILED DESCRIPTION

Various exemplary systems and methods for developing a mobile network are described herein. Such systems and methods include the presentation of a collection or ranked menu of mobile network sites that are interesting and relevant to users of mobile communications devices and encourage the users to visit those mobile network sites. As users discover mobile network sites, publishers of content on mobile network sites are incentivized to join and further develop the mobile network. Users of mobile communications devices may register positive and/or negative reactions to various mobile network sites, so that any given user may be presented with a ranked list or menu of mobile network sites. In some embodiments, a user may personalize their menu to offer the user quick access to mobile network sites that are relevant to the user's interests.

Also provided herein are various exemplary monetization platforms for publishers of content for mobile communications devices and/or for those that administer or maintain a mobile network. Growth of a mobile network may be monitored and studied, so that, for example, market research may be conducted to provide information such as the demographics of an audience of an ad on a particular publisher's mobile network site, and/or how much traffic of a given publisher may go through the mobile network. This information may increase the accuracy of pricing for inventoried content (such as advertisements) featured on a particular publisher's mobile network site and distributed through the mobile network via a ranked menu or listing of mobile network sites.

Thus, various exemplary embodiments presented herein take a directory-based approach to mobile network development, rather than a search-driven approach. A directory, such as a database of mobile network sites with associated information about each mobile network site and the relationships among them, may be maintained. Small and succinct content presentations may be composed for mobile communications devices, showing some mobile network sites in the directory, along with descriptors and snippets related to the mobile network sites, so that the need for user actions in exploring the mobile network may be minimized, and user actions may be more fully informed and efficiently directed. The inclusion of icons, such as trademark logos or RSS symbols, in the presentations may contribute to this efficiency, in that a single image may provide the informational equivalent of several words.

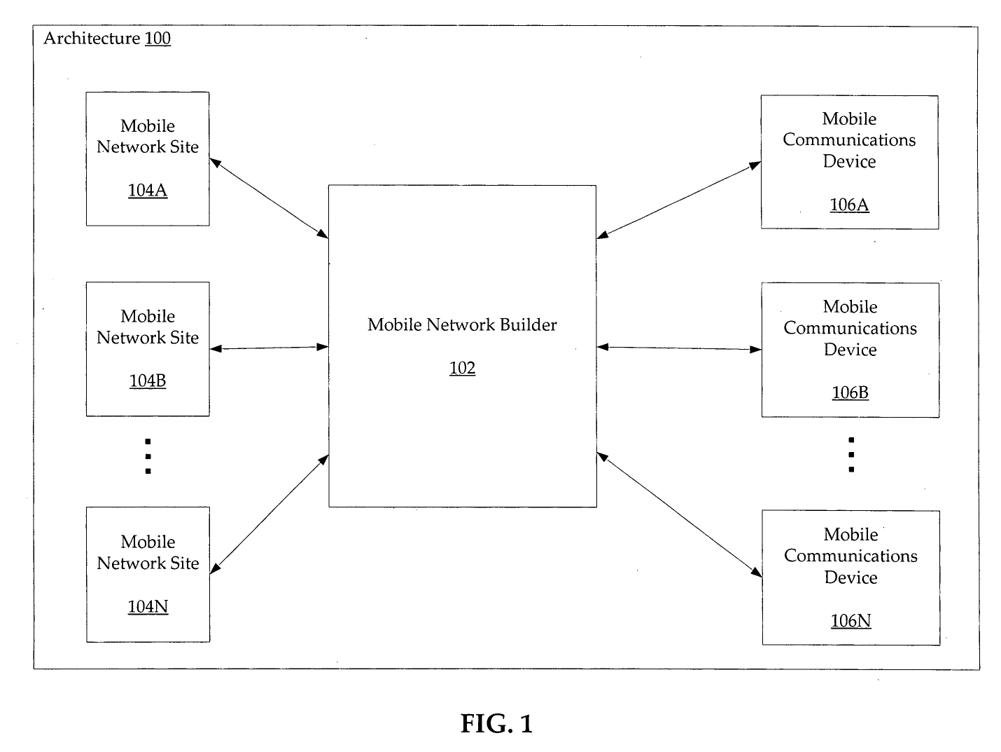

FIG. 1 is a block diagram of an exemplary architecture in which various embodiments of developing a mobile network may be practiced. The exemplary architecture 100 includes a mobile network builder 102, mobile network sites 104A-104N (generically described as mobile network sites 104), and mobile communications devices 106A-106N (generically described as mobile communications devices 106). According to various exemplary systems and methods, the mobile network builder 102 may be maintained by an administrator of the mobile network, and the mobile network builder 102 may reside on or be associated with one or more servers. Additionally, the administrator may be in a position to monitor traffic between the mobile network sites 104 and the mobile communications devices 106, including the behavior of the users of the mobile communications devices 106.

In one exemplary embodiment, the mobile network sites 104 are provided on a mobile network by publishers of content (e.g. ESPN.com, CNN.com, etc). Mobile communication devices 106, such as mobile phones, personal digital assistants, etc. may be employed by users to access the mobile network sites 104. As the users access the mobile network sites 104, their interactions (e.g. viewing, viewing duration, link clicking behavior, etc) with content on the mobile network sites 104 may be monitored and/or tracked by an administrator of the mobile network via the mobile network builder 102. Further, the characteristics of the mobile communications device 106 (e.g. make, model, mobile communications device network carrier, etc) may also be tracked by the administrator of the mobile network via the mobile network builder 102.

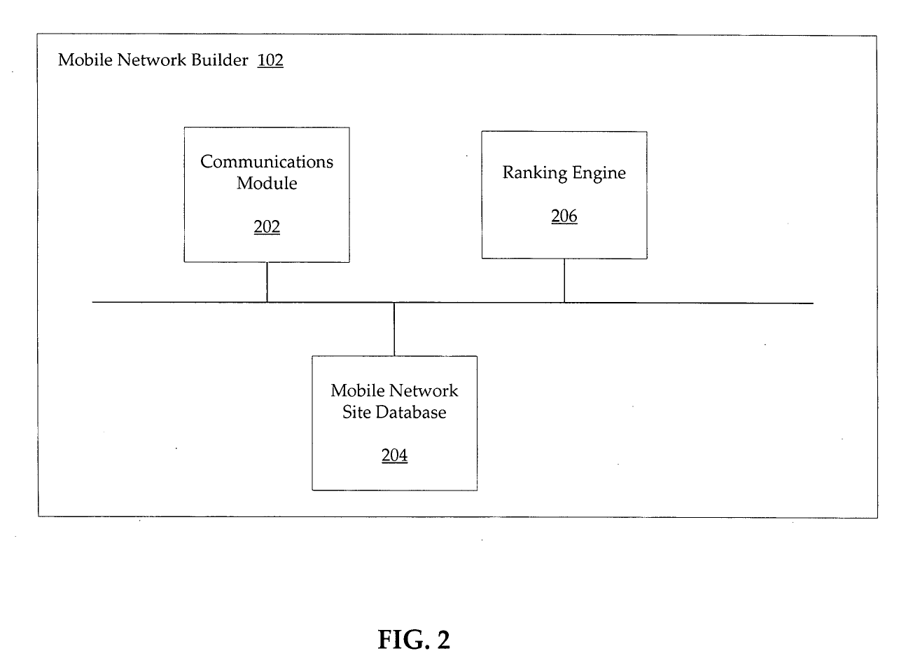

FIG. 2 shows an exemplary mobile network builder 102 (FIG. 1). The exemplary mobile network builder 102 includes a communications module 202, a mobile network site database 204, and a ranking engine 206.

According to various exemplary systems and methods, the communications module 202 may be configured to enable the mobile network builder 102 to communicate with publishers of mobile network sites, such as mobile network sites 104 (FIG. 1). For example, the communications module 202 may be configured to receive a request from a publisher to include a mobile network site in a ranked menu of mobile network sites. The communications module 202 may be configured to send the ranked menu of mobile network sites to mobile communications devices, such as mobile communications devices 106 (FIG. 1). The communications module 202 may be configured to receive a communication from a mobile communications device indicating that a mobile network site should have a different rank, as determined by the respective user of the mobile communications device. The communications module 202 may be further configured to send an updated ranked menu to the mobile communications devices. According to a further exemplary embodiment, the communications module 202 is configured to receive information about each time the mobile network site is accessed by the mobile communications devices, and to receive information about each time an advertisement appearing on the mobile network site is clicked or activated by users of the mobile communications devices. In yet a further embodiment, the communications module 202 may be configured to send a link to the ranked menu of mobile network sites to a menu maintained by a carrier of a mobile communications network. For Example, a carrier of a mobile communications network such as Verizon® may provide their own menu to their network users wherein a link to a ranked menu as described herein may be included on the menu provided by Verizon®.

The exemplary mobile network builder 102, according to one embodiment, may comprise one or more databases, such as the mobile network site database 204, and/or other databases. Such databases may store information about publishers, their respective mobile network sites, mobile communications devices of users, and/or the behavior and interactions of users with respect to the mobile network sites. This information may be used for various purposes, including market research and/or advertising. For example, an administrator of a mobile network may have a contractual arrangement with one or more publishers of mobile network sites for featuring various advertisements on those mobile network sites. The administrator may be able to employ a database such as mobile network site database 204 to determine the amount and nature of traffic (i.e. how often a particular mobile network site is accessed, duration of access, extent of interactions or clicks on the mobile network site, etc) received by a particular mobile network site and use this information to influence the ranking of the mobile network site on ranked menus displayed to targeted users of mobile communications devices. For example, the mobile network may have a contractual arrangement to feature advertisements on a particular mobile network site that is relatively new to the mobile network. The mobile network administrator may purposely increase the ranking of the particular new mobile network site on a ranked menu in order to increase the number of users of mobile communications devices that may access the mobile network site and/or click on the featured advertisements. The effectiveness of such campaigns to increase traffic and/or interactions with various advertisements may be determined by collecting, storing and analyzing the associated data maintained in databases such as the mobile network site database 204.

The ranking engine 206, according to one exemplary embodiment, is configured to include mobile network sites in a ranked menu of mobile network sites, and to update the ranked menu of mobile network sites. Such ranking may be based upon users of mobile communications devices sending information that is received by the mobile network builder 102 that indicates whether the user feels a particular mobile network site should have an increased or decreased ranking in a ranked menu. The ranking engine 206 may change the relative ranks of mobile network sites so that the communications module 202 may send accurately ranked lists of the mobile network sites to users of mobile communications devices. Additionally, the ranking engine 206 may ensure that the ranked menu or directory of mobile network sites maintained in a database (e.g. mobile network site database 204) is in the proper order for presentation to a particular user.

According to further exemplary embodiments, the ranking engine 206 may take into account and base rankings on such factors as how often a particular mobile network site is accessed by various mobile communications devices. The ranking engine 206 may base rankings on information received about how often a particular advertisement appearing on a mobile network site is clicked or activated by a user of a mobile communications device. Additionally, the ranking engine 206 may base rankings on information received about how often a link to a ranked menu on a menu maintained by a carrier of a mobile communications network (e.g. Sprint®) is clicked or activated by a user of the mobile communications device. The ranking engine 206 may process these various forms of received information (in addition to other information) in order to update the ranked menu of mobile network sites.

The embodiments discussed herein are illustrative. As these embodiments are described with reference to illustrations, various modifications or adaptations of the methods and/or specific structures described may become apparent to those skilled in the art. The herein-described components and functions can be comprised of instructions that are stored on a computer-readable storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with the invention. Those skilled in the art are familiar with instructions, processor(s), and storage medium.

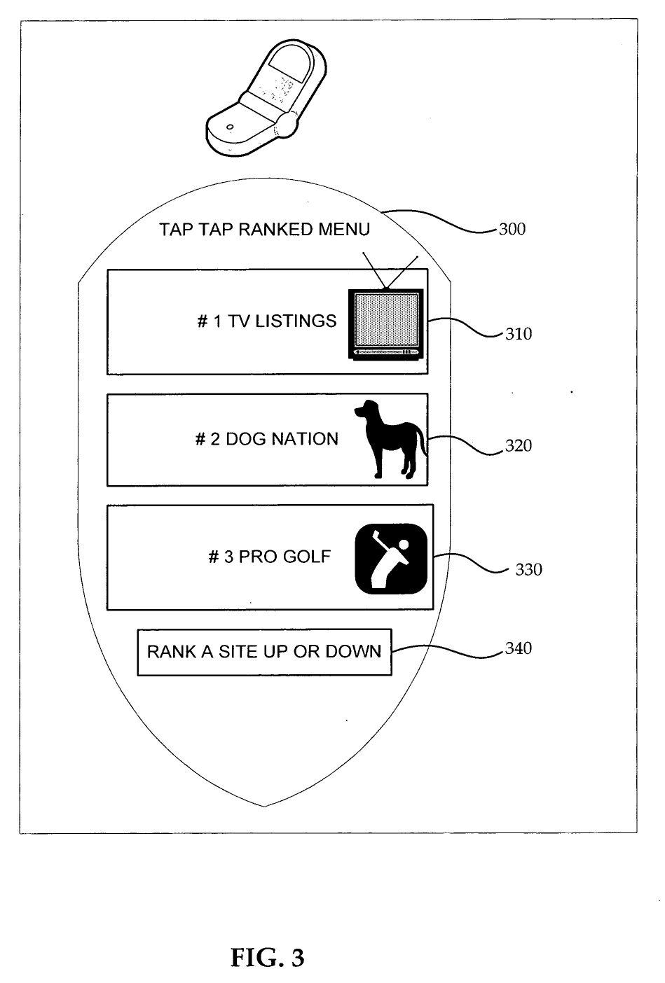

FIG. 3 is a screenshot of an exemplary ranked menu of mobile network sites. The exemplary ranked menu 300 includes a number one (or top ranked) selection for a mobile network site associated with television listings 310, a number two selection for a mobile network site associated with dogs 320, a number three selection for a mobile network site associated with professional golf 330, and a rank indicator selection 340.

The ranked menu 300, according to one exemplary embodiment, takes a directory-based approach to mobile network development, rather than a search-driven approach. Very small and succinct content presentations, including various graphic elements, may be composed for mobile communications devices, along with descriptors and snippets related to the mobile network sites, so that the need for user actions in exploring the mobile network may be minimized, and user actions may be more fully informed and efficiently directed.

In various exemplary embodiments, the ranked menu 300 is based on the ranking engine 206 (FIG. 2) processing the mobile network sites to result in a ranked menu of mobile network sites, and further updating the ranked menu 300. Such ranking may be based upon users of mobile communications devices sending information via the rank indicator selection 340 that indicates whether the user feels a particular mobile network site should have an increased or decreased ranking in a ranked menu. For example, the user of the mobile communications device having the ranked menu 300 may use the indicator selection 340 to indicate that he or she feels the number three selection for a mobile network site associated with professional golf 330 should have an increased ranking in the ranked menu 300. Accordingly, the ranking engine 206 may process the received information from the user to create an updated ranked menu wherein the mobile network site associated with professional golf appears in place of the mobile network site associated with television listings 310, or in place of the number two selection for a mobile network site associated with dogs 320. The displaced mobile network site may receive the former ranking of its successor, or it may receive a ranking of one less than its previous ranking (with each successive mobile network site receiving a ranking of one less than before), or it may be moved further down or even off of the ranked menu 300. Further, the ranked menu 300 may be determined on a user by user basis, or the ranked menu 300 may be determined on a mobile network-wide basis, and/or any other combination thereof.

According to further exemplary embodiments, the ranked menu may be based on such factors as how often a particular mobile network site is accessed by various mobile communications devices, or how often a particular advertisement appearing on a mobile network site is clicked or activated by a user of the mobile communications device, and/or how often a link to a ranked menu on a menu maintained by a carrier of a mobile communications network is clicked or activated by the user of the mobile communications device. The ranking engine 206 may process these various forms of received information (in addition to other information) in order to update the ranked menu 300.

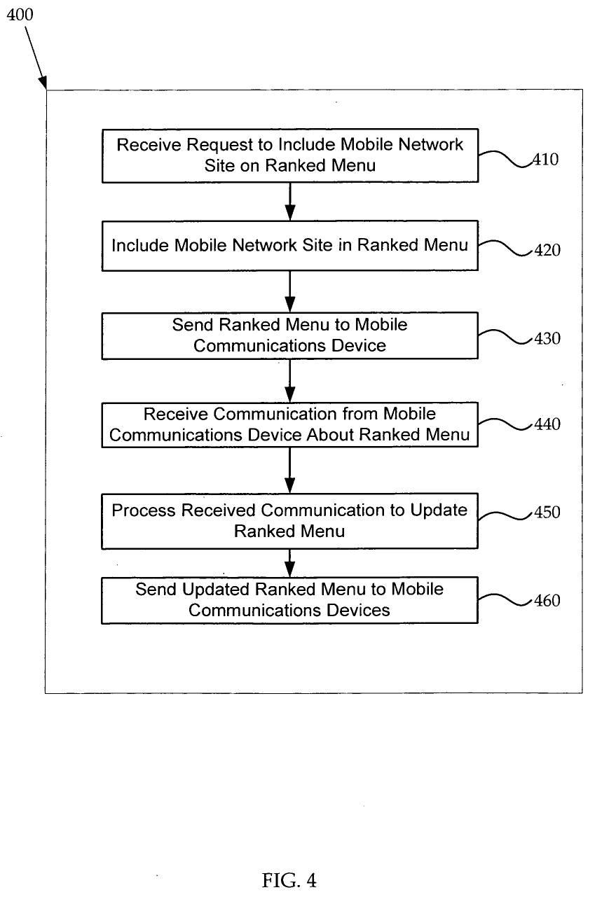

FIG. 4 is a flow chart of an exemplary method for developing a mobile network.

At step 410 of the exemplary method 400, a request is received to include a mobile network site on a ranked menu of mobile network sites. For example, a request may be received via the communications module 202 (FIG. 2) of the mobile network builder 102 (FIGS. 1-2) to include the mobile network site associated with professional golf 330 (FIG. 3) on the ranked menu 300 (FIG. 3).

At step 420, a mobile network site is included in a ranked menu. For instance, the mobile network site associated with professional golf 330 may be included in the ranked menu 300.

At step 430, a ranked menu is sent to a mobile communications device. According to one exemplary embodiment, the ranked menu 300 may be sent by the communications module 202 to mobile communications device 106A (FIG. 1).

At step 440, a communication is received from a mobile communications device about a ranked menu. Based on one exemplary method, the user of the mobile communications device having the ranked menu 300 may use the indicator selection 340 (FIG. 3) to indicate that he or she feels the number three selection for a mobile network site associated with professional golf 330 should have an increased ranking in the ranked menu 300.

At step 450, a received communication is processed to update the ranked menu. According to one exemplary embodiment, the ranking engine 206 (FIG. 2) may process a received communication from a user of mobile communications device 106A to create an update to the ranked menu 300 wherein the mobile network site associated with professional golf 330 appears in place of the mobile network site associated with television listings 310 (FIG. 3).

At step 460, an updated ranked menu is sent to one or more mobile communications devices. For example, the mobile communications module 202 may send the ranked menu 300 featuring the mobile network site associated with professional golf 330 in place of the mobile network site associated with television listings 310 to mobile communications device 106A.

While various embodiments have been described above, it should be understood that they have been presented by way of example only, and not limitation. Thus, the breadth and scope of a preferred embodiment should not be limited by any of the above-described exemplary embodiments.

What is claimed is:

1. A method for developing a mobile network, the method comprising:
receiving a request to include a mobile network site in a ranked menu of mobile network sites;
including the mobile network site in the ranked menu of mobile network sites;
sending the ranked menu of mobile network sites to a mobile communications device;
receiving a communication from the mobile communications device indicating that the mobile network site should have a different rank;
processing the received communication to update the ranked menu of mobile network sites; and
sending the updated ranked menu to the mobile communications device.

2. The method of claim 1, the method further comprising:
receiving information about each time the mobile network site is accessed by the mobile communications device.

3. The method of claim 1, the method further comprising:
receiving information about each time content appearing on the mobile network site is accessed by the mobile communications device.

4. The method of claim 1, the method further comprising:
receiving information about each time an advertisement appearing on the mobile network site is clicked or activated by a user of the mobile communications device.

5. The method of claim 2, the method further comprising:
processing the received information to update the ranked menu of mobile network sites.

6. The method of claim 3, the method further comprising:
processing the received information to update the ranked menu of mobile network sites.

7. The method of claim 4, the method further comprising:
processing the received information to update the ranked menu of mobile network sites.

8. The method of claim 1, the method further comprising:
displaying a link to the updated ranked menu on a menu maintained by a carrier of a mobile communications network.

9. The method of claim 8, the method further comprising:
receiving information about each time the link to the updated ranked menu on the menu maintained by the carrier of the mobile communications network is clicked or activated by a user of the mobile communications device.

10. The method of claim 9, the method further comprising:
processing the received information to update the ranked menu of mobile network sites.

11. The method of claim 1, wherein the different rank is a higher rank or a lower rank.

12. A system for developing a mobile network, the system comprising:
a communications module configured to receive a request to include a mobile network site in a ranked menu of mobile network sites, to send the ranked menu of mobile network sites to a mobile communications device, and to receive a communication from the mobile communications device indicating that the mobile network site should have a different rank;
a ranking engine configured to include the mobile network site in the ranked menu of mobile network sites, and to process the received communication to update the ranked menu of mobile network sites;
a mobile network site database configured to store information about the mobile network site and the ranked menu of mobile networks sites; and
the communications module further configured to send the updated ranked menu to the mobile communications device.

13. The system of claim 12, wherein the information includes ranking data.

14. The system of claim 12, wherein the communications module is further configured to receive information about each time the mobile network site is accessed by the mobile communications device.

15. The system of claim 12, wherein the communications module is further configured to receive information about each time an advertisement appearing on the mobile network site is clicked or activated by a user of the mobile communications device.

16. The system of claim 14, wherein the ranking engine is further configured to process the received information to update the ranked menu of mobile network sites.

17. The system of claim 15, wherein the ranking engine is further configured to process the received information to update the ranked menu of mobile network sites.

18. The method of claim 12, wherein the communications module is further configured to send a link to the updated ranked menu to a menu maintained by a carrier of a mobile communications network.

19. A computer readable medium having embedded thereon a program, the program being executable by a processor for performing a method for developing a mobile network, the method comprising:
receiving a request to include a mobile network site in a ranked menu of mobile network sites;
including the mobile network site in the ranked menu of mobile network sites;
sending the ranked menu of mobile network sites to a mobile communications device;
receiving a communication from the mobile communications device indicating that the mobile network site should have a different rank;
processing the received communication to update the ranked menu of mobile network sites; and
sending the updated ranked menu to the mobile communications device.

20. The computer readable medium of claim 20, the method further comprising:
receiving information about each time the mobile network site is accessed by the mobile communications device.
